(19) United States
(12) Patent Application Publication
(10) Pub. No.: US 2024/0143491 A1
(43) Pub. Date: May 2, 2024

(54) SIMULATION BASED TESTING FOR TRAJECTORY PLANNERS

(71) Applicant: Five Al Limited, Cambridge (GB)

(72) Inventors: Benedict Peters, Cambridge (GB); Marco Ferri, Cambridge (GB)

(73) Assignee: Five Al Limited, Cambridge (GB)

(21) Appl. No.: 18/279,773

(22) PCT Filed: Feb. 28, 2022
(86) PCT No.: PCT/EP2022/055008

§ 371 Date: Aug. 31, 2023

(30) Foreign Application Priority Data
Mar. 1, 2021 (GB) 2102892.3

(51) Int. Cl. G06F 11/36

(52) U.S. Cl. CPC G06F 11/3692; G06F 11/3684

(57) ABSTRACT

A computer-implemented method of evaluating the performance of a trajectory planner in simulation comprises miming first instances of a scenario in a simulator, the first instances run with a first set of parameterizations of the scenario, the trajectory planner used to control an ego agent responsive in each scenario instance; evaluating performance of the trajectory planner in each scenario instance, thereby computing a set of test results for the first set of scenario parameterizations; identifying at least one target parameterization of the first set based on the set of test results; and based on the target parameterization, determining a second set of parameterizations of the scenario for miming second instances of the scenario for exploring a subspace of the parameter space in the vicinity of the target parameterization.

### TECHNICAL FIELD

The present disclosure pertains to methods for evaluating the performance of trajectory planners in simulated scenarios, and computer programs and systems for implementing the same. Such planners are capable of autonomously planning ego trajectories for fully/semi-autonomous vehicles or other mobile robots. Example applications include ADS (Autonomous Driving System) and ADAS (Advanced Driver Assist System) performance testing.

### BACKGROUND

There have been major and rapid developments in the field of autonomous vehicles. An autonomous vehicle (AV) is a vehicle which is equipped with sensors and control systems which enable it to operate without a human controlling its behaviour. An autonomous vehicle is equipped with sensors which enable it to perceive its physical environment, such sensors including for example cameras, radar and lidar. Autonomous vehicles are equipped with suitably programmed computers which are capable of processing data received from the sensors and making safe and predictable decisions based on the context which has been perceived by the sensors. An autonomous vehicle may be fully autonomous (in that it is designed to operate with no human supervision or intervention, at least in certain circumstances) or semi-autonomous. Semi-autonomous systems require varying levels of human oversight and intervention, such systems including Advanced Driver Assist Systems and level three Autonomous Driving Systems. There are different facets to testing the behaviour of the sensors and control systems aboard a particular autonomous vehicle, or a type of autonomous vehicle.

Safety is an increasing challenge as the level of autonomy increases. In autonomous driving, the importance of guaranteed safety has been recognized. Guaranteed safety does not necessarily imply zero accidents, but rather means guaranteeing that some minimum level of safety is met in defined circumstances. It is generally assumed this minimum level of safety must significantly exceed that of human drivers for autonomous driving to be viable.

According to Shalev-Shwartz et al. “On a Formal Model of Safe and Scalable Self-driving Cars” (2017), arXiv:1708.06374 (the RSS Paper), which is incorporated herein by reference in its entirety, human driving is estimated to cause of the order 10⁻⁶ severe accidents per hour. On the assumption that autonomous driving systems will need to reduce this by at least three order of magnitude, the RSS Paper concludes that a minimum safety level of the order of 10⁻⁹ severe accidents per hour needs to be guaranteed, noting that a pure data-driven approach would therefore require vast quantities of driving data to be collected every time a change is made to the software or hardware of the AV system.

The RSS paper provides a model-based approach to guaranteed safety. A rule-based Responsibility-Sensitive Safety (RSS) model is constructed by formalizing a small number of “common sense” driving rules:
“1. Do not hit someone from behind.
2. Do not cut-in recklessly.
3. Right-of-way is given, not taken.
4. Be careful of areas with limited visibility.
5. If you can avoid an accident without causing another one, you must do it.”

The RSS model is presented as provably safe, in the sense that, if all agents were to adhere to the rules of the RSS model at all times, no accidents would occur. The aim is to reduce, by several orders of magnitude, the amount of driving data that needs to be collected in order to demonstrate the required safety level.

A safety model (such as RSS) can be used as a basis for evaluating the quality of trajectories realized by an ego agent in a real or simulated scenario under the control of an autonomous system (stack). The stack is tested by exposing it to different scenarios, and evaluating the resulting ego trajectories for compliance with rules of the safety model (rules-based testing). A rules-based testing approach can also be applied to other facets of performance, such as comfort or progress towards a defined goal.

### SUMMARY

The present disclosure pertains generally to stack testing based on simulated scenarios, via a targeted exploration of a scenario space (a parameter space of a simulated scenario). The present techniques increase efficiency (by reducing the number of required simulations) whilst increasing saliency of results, by focusing testing on anomalous or otherwise interesting regions of the scenario space. “Target” parameterizations of interest are identified by comparing their test results to those of neighbouring parameterizations in the scenario space.

A first aspect herein is directed to a computer-implemented method of evaluating the performance of a trajectory planner in simulation, the method comprising: running first instances of a scenario in a simulator, the first instances run with a first set of parameterizations of the scenario, the trajectory planner used to control an ego agent responsive in each scenario instance; evaluating performance of the trajectory planner in each first scenario instance, thereby computing a first set of test results for the first set of parameterizations; identifying at least one first target parameterization of the first set of parameterizations based on the first set of test results, by comparing a test result computed for the first target parameterization with respective test results computed for a first subset of neighbouring parameterizations of the first set, wherein the first subset of neighbouring parameterizations neighbour the first target parameterization in a parameter space of the scenario; and based on the first target parameterization, determining a second set of parameterizations of the scenario for running second instances of the scenario for exploring a first subspace of the parameter space in the vicinity of the first target parameterization.

The method can, for example, be tuned to provide a form of anomaly detection and/or edge detection within the parameters space. For example, a given parameterization may only be chosen for further exploration if it deviates from a relatively high proportion of its neighbours in terms of test results. This is referred to as a form of anomaly detection, as the aim is generally to identify relatively ‘isolated’ anomalies in the parameter space. As that proportion of neighbouring parametrizations is reduced, the method is more resemblant of edge detection. Edge detection can be used identify and explore “edge regions” in the parameter space. For example, with pass/fail results, there may be a relatively large region of the space over which pass results are obtained that neighbours a relatively large region for which fail results are obtained. The present techniques can be applied to the test results in order to detect parameterizations along the edge between those regions, and explore those regions in greater detail (to more accurately determine the pass/fail boundary).

In embodiments, the method may comprise: exploring the first subspace of the parameter space by running second instances of the scenario in the simulator with the second set of parameterizations; and evaluating the performance of the trajectory planner in each second scenario instance, thereby computing a second set of test results for the second scenario instances.

The method may comprise: identifying at least one second target parametrization of the second set is identified in the same way, by comparing a test result computed for the second target parameterization with respective test results computed for a second subset of neighbouring parameterizations, wherein the second subset of neighbouring parameterizations neighbour the first target parameterization in a parameter space of the scenario, wherein the second subset of neighbouring parametrizations is a subset of the second set of parameterizations or a subset of the first set of parameterizations and the second set of parameterizations combined; and based on the second target parameterization, determining a third set of parameterizations of the scenario for running third instances of the scenario for exploring a second subspace of the parameter space in the vicinity of the second target parameterization.

The second (or third) instances may be run automatically in response to the identification of the first (or second) target parameterisation, or in response to a user input at a user interface.

The second and third instances may be run automatically, and the method may continue running instances iteratively until a terminating condition is satisfied.

The first (or second) target parameterization may be identified by detecting one or more discrepancies between the test result of the first (or second) target parameterization and the respective test results of the first (or second) subset of neighbouring parameterizations.

The first (or second) target parameterization may be identified by determining that the test result of the first (or second) target parameterization differs from each test result of more than a predetermined number of the first (or second) subset of neighbouring parameterizations.

The performance of the trajectory planner may be evaluated based on one or more predetermined trajectory evaluation rules. The one or more predetermined trajectory evaluation rules may, for example, pertain to safety, comfort, progress towards a defined goal, or any combination thereof.

Each test result may be categorical. For example, each test result may be computed from a numerical performance score based on at least one threshold.

The second set of parameterizations may be outputted to a user, via a user interface, for manually instigating the second instances of the scenario.

A test result may be computed for each parameterization of the first (or second) set of parameterizations from a single first (or second) scenario instance or multiple first (or second) scenario instances.

For example, the simulator may be non-deterministic. Multiple first (or second) scenario instances may be run for each first (or second) parameterization, and the test result for each first (or second) parameterization may be an aggregate test result for the multiple first (or second) scenario instances.

The second (or third) set of parametrizations may have a higher density in the first (or second) subspace of the parameter space than the first (or second) set of parametrizations.

The first (or second) set of parameterizations may be uniformly spaced in the parameter space with a first (or second) uniform density, and the second (or third) set of parameterizations may be uniformly spaced with a second (or third) uniform density greater than the first (or second) uniform density.

The trajectory planner may be tested in combination with a controller, a perception system, and/or a prediction system.

The trajectory planner may be used to control an ego agent responsive to at least one other agent in each scenario instance.

A second aspect herein is directed to a computer-implemented method of evaluating the performance of a trajectory planner in simulation, the method comprising: running first instances of a scenario in a simulator, the first instances run with a first set of parameterizations of the scenario, the trajectory planner used to control an ego agent responsive in each scenario instance;

evaluating performance of the trajectory planner in each scenario instance, thereby computing a set of test results for the first set of scenario parameterizations; identifying at least one target parameterization of the first set based on the set of test results; and based on the target parameterization, determining a second set of parameterizations of the scenario for running second instances of the scenario for exploring a subspace of the parameter space in the vicinity of the target parameterization.

In embodiments of the first or second aspect, the at least one target parameterization may be identified by comparing a test result computed for the target parameterization with test results computed for neighbouring parameterizations of the first set that neighbour the target parameterization in a parameter space of the scenario.

For example, the target parameterization may be an anomalous parameterization, identified by applying anomaly detection to the first set of test results.

For example, the anomalous parameterization may be identified based on a discrepancy between the test result of the anomalous parameterization and the test results of the neighbouring parameterizations.

The set of test results may pertain to one or multiple trajectory evaluation rules.

The target parameterization may be identified by determining that the test result of the target parameterization differs from the test results of more than a predetermined number of the neighbouring parameterizations.

The method may comprise running second instances of the scenario in the simulator with the second set of parameterizations to explore the subspace, and evaluating the performance of the trajectory planner in each second scenario instance, thereby obtaining a test result for each second scenario instance. The second instances may be run automatically in response to the identification of the target parameterisation, or in response to a user input at a user interface.

The method may be iterative, wherein at least a second target parametrization of the second set is identified in the same way, based on neighbouring parameterizations of the second set or the first and second sets combined, and used to identify a third set of parameterizations for a exploring second subspace of the parameter space in the vicinity of the second target parameterization. Third instances of the scenario may be automatically run with the third set of parameterizations.

The iterative method continues until some terminating condition is satisfied (e.g. no further target parameterizations are identified, or a predetermined iteration limit is reached).

Alternatively, the second set of parameterizations may be outputted to a user, via a user interface, for manually instigating the second instances of the scenario.

The performance of the trajectory planner may be evaluated based on one or more predetermined trajectory evaluation rules. For example, rules pertaining to safety, comfort, progress towards a defined goal, or any combination thereof. For example, the predetermined rules may comprise one or more rules of defined safety model.

The test results may be categorical (e.g. binary pass/fail results, or non-binary categorical results). Alternatively, the test results may be numerical (e.g. number of percentage of failures or passes).

A test result may be computed for each parameterization from one scenario instance or multiple scenario instances. For example, the simulator may be non-deterministic, and multiple scenario instances may be run for each parameterization. In that event, the test result for each parameterization may be an aggregate test result for the multiple scenario instances.

The second set of parametrizations may have a higher density (lower spacing) in the subspace of the parameter space than the first set of parametrizations.

For example, parameterizations of the first set may be uniformly spaced in the parameter space, and parameterizations of the second set may also be uniformly spaced but with a reduced spacing (higher density).

Alternatively or in addition to identifying anomalous detections, the method can also be applied to identify and explore “edge regions” in the parameter space. For example, with pass/fail results, there may be a relatively large region of the space over which pass results are obtained that neighbours a relatively large region for which fail results are obtained. The present techniques can be applied to the test results in order to detect parameterizations along the edge between those regions, and explore those regions in greater detail (to more accurately determine the pass/fail boundary).

The trajectory planner may be used to control an ego agent responsive to at least one other agent in each scenario instance.

The first set of parameterizations may be predetermined or fixed.

The trajectory planner may or may not be tested in combination with one or more other components, such as a perception system, controller, and/or prediction system (to the extent such components are separable from the trajectory planner).

A third aspect herein is directed to a computer-implemented method of evaluating the performance of a trajectory planner in simulation, the method comprising: receiving initial test results, obtained by running first instances of a scenario in a simulator, the first instances run with a first set of parameterizations of the scenario, the trajectory planner used to control an ego agent in each scenario instance, and evaluating performance of the trajectory planner in each scenario instance, thereby computing a set of test results for the first set of scenario parameterizations; identifying at least one target parameterization of the first set, by comparing a test result, of the initial test results, computed for the target parameterization with test results, of the initial test results, computed for neighbouring parameterizations of the first set that neighbour the target parameterization in a parameter space of the scenario; and based on the target parameterization, determining a second set of parameterizations of the scenario for running second instances of the scenario for exploring a subspace of the parameter space in the vicinity of the target parameterization.

Further aspects provide a computer system comprising one or more computers configured to implement the method of the first, second or third aspect or any embodiment thereof, and computer instructions for programming a computer system to implement the same.

### BRIEF DESCRIPTION OF FIGURES

For a better understanding of the present disclosure, and to show how embodiments of the same may be carried into effect, reference is made by way of example only to the following figures in which:

FIG. 1A shows a schematic function block diagram of an autonomous vehicle stack;

FIG. 1B shows a schematic overview of an autonomous vehicle testing paradigm;

FIG. 1C shows a schematic block diagram of a scenario extraction pipeline;

FIG. 2 shows a schematic block diagram of a testing pipeline;

FIG. 2A shows further details of a possible implementation of the testing pipeline;

FIG. 3A shows an example of a rule tree evaluated within a test oracle;

FIG. 3B shows an example output of a node of a rule tree;

FIG. 4A shows an example of a rule tree to be evaluated within a test oracle;

FIG. 4B shows a second example of a rule tree evaluated on a set of scenario ground truth data;

FIG. 5A shows a flowchart for a scenario exploration method;

FIG. 5B schematically deposits possible outputs that may be obtained at different stages of the scenario exploration method; and

FIGS. 6A to 6G show different views of an example graphical user interface for exploring a scenario space in a targeted fashion based on obtained test results.

### DETAILED DESCRIPTION

The described embodiments provide a testing pipeline to facilitate rules-based testing of AV stacks. A rule editor allows custom rules to be defined and evaluated against trajectories realized in real or simulated scenarios. Such rules may evaluate different facets of safety, but also other factors such as comfort and progress towards some defined goal.

Herein, a “scenario” can be real or simulated and involves an ego agent (ego vehicle or other mobile robot) moving within an environment (e.g. within a particular road layout), typically in the presence of one or more other agents (other vehicles, pedestrians, cyclists, animals etc.). A “trace” is a history of an agent's (or actor's) location and motion over the course of a scenario. There are many ways a trace can be represented. Trace data will typically include spatial and motion data of an agent within the environment. The term is used in relation to both real scenarios (with physical traces) and simulated scenarios (with simulated traces). The following description considers simulated scenarios. Simulation-based testing can be used in combination with real-world testing.

The described testing pipeline can be applied to test stack performance in real or simulated scenarios. Specific techniques are described later that facilitate efficient exploration of a parameter space of a simulated scenario, to increase the saliency of the results whilst reducing the number of required simulations.

In a simulation context, the term scenario may be used in relation to both the input to a simulator (such as an abstract scenario description) and the output of the simulator (such as the traces). It will be clear in context which is referred to. As described in further detail below, a scenario instance refers to an instantiation of a scenario, having configurable parameter(s), with a particular “parameterization” (value or combination of values of the parameter(s)). That is, a parameterization means a set of one or more values of one or more scenario parameters. The parameter value(s) form part of the input to the simulator.

A typical AV stack includes perception, prediction, planning and control (sub)systems. The term “planning” is used herein to refer to autonomous decision-making capability (such as trajectory planning) whilst “control” is used to refer to the generation of control signals for carrying out autonomous decisions. The extent to which planning and control are integrated or separable can vary significantly between different stack implementations—in some stacks, these may be so tightly coupled as to be indistinguishable (e.g. such stacks could plan in terms of control signals directly), whereas other stacks may be architected in a way that draws a clear distinction between the two (e.g. with planning in terms of trajectories, and with separate control optimizations to determine how best to execute a planned trajectory at the control signal level). Unless otherwise indicated, the planning and control terminology used herein does not imply any particular coupling or separation of those aspects. An example form of AV stack will now be described in further detail, to provide relevant context to the subsequent description.

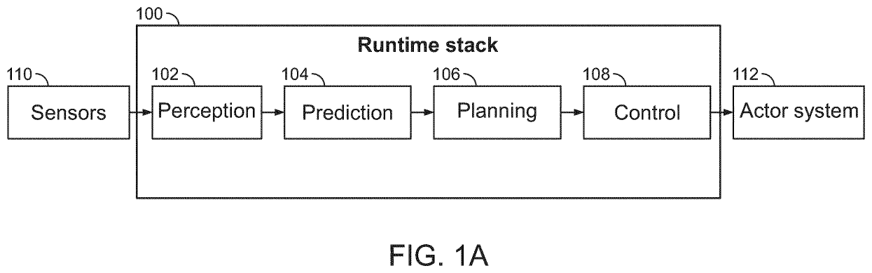

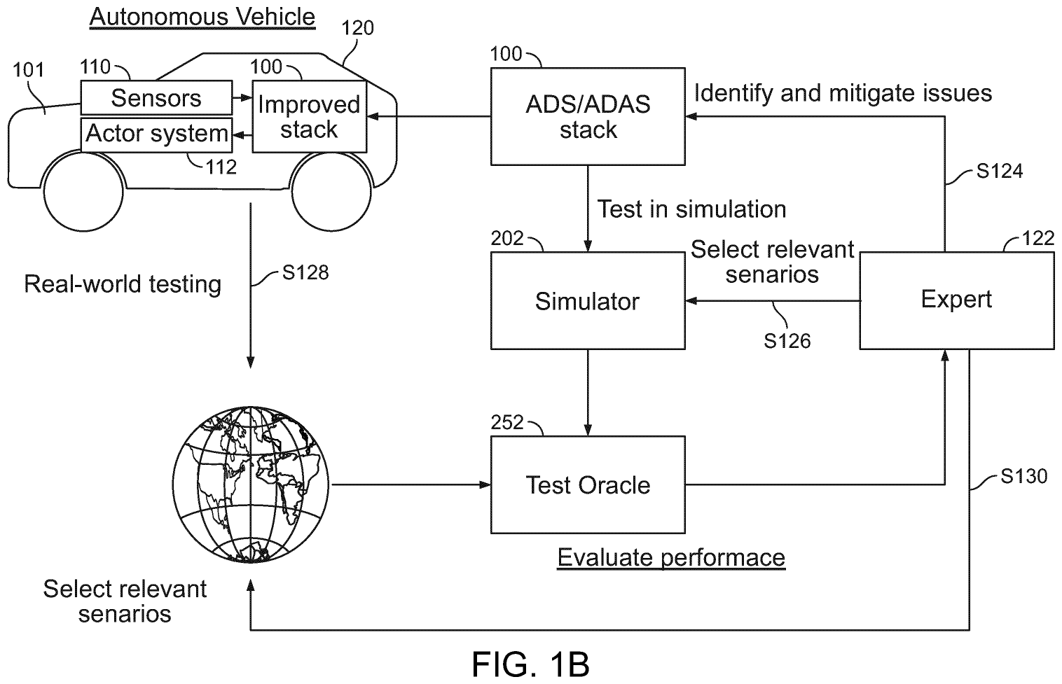

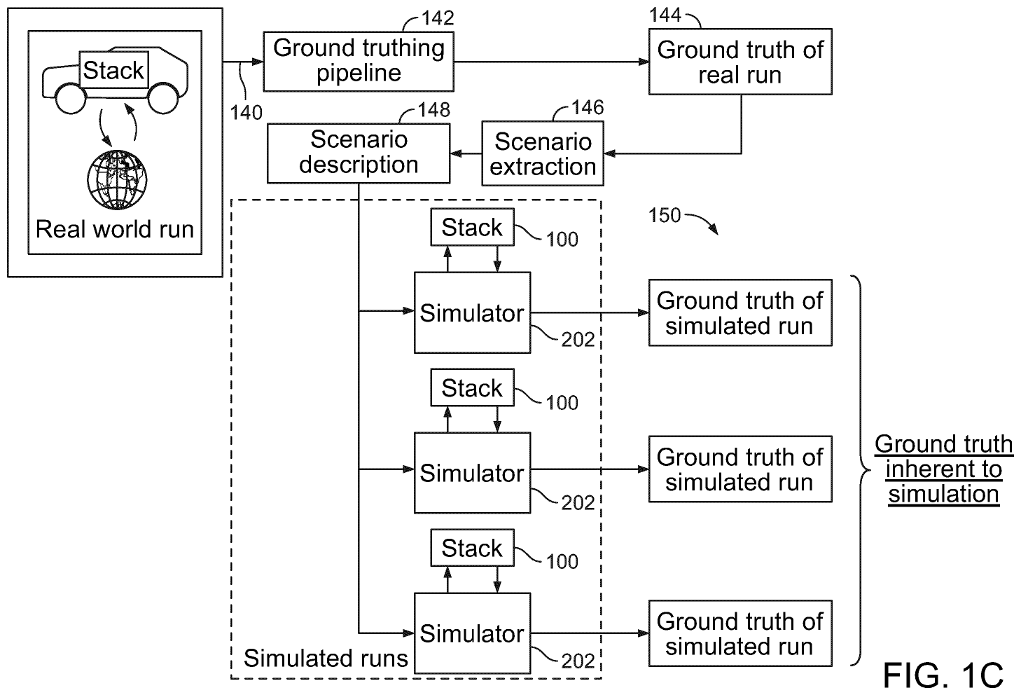

FIG. 1A shows a highly schematic block diagram of a runtime stack 100 for an autonomous vehicle (AV), also referred to herein as an ego vehicle (EV). The run time stack 100 is shown to comprise a perception system 102, a prediction system 104, a planner 106 and a controller 108.

In a real-world context, the perception system 102 would receive sensor outputs from an on-board sensor system 110 of the AV, and use those sensor outputs to detect external agents and measure their physical state, such as their position, velocity, acceleration etc. The on-board sensor system 110 can take different forms but generally comprises a variety of sensors such as image capture devices (cameras/optical sensors), lidar and/or radar unit(s), satellite-positioning sensor(s) (GPS etc.), motion/inertial sensor(s) (accelerometers, gyroscopes etc.) etc. The onboard sensor system 110 thus provides rich sensor data from which it is possible to extract detailed information about the surrounding environment, and the state of the AV and any external actors (vehicles, pedestrians, cyclists etc.) within that environment. The sensor outputs typically comprise sensor data of multiple sensor modalities such as stereo images from one or more stereo optical sensors, lidar, radar etc. Sensor data of multiple sensor modalities may be combined using filters, fusion components etc.

The perception system 102 typically comprises multiple perception components which co-operate to interpret the sensor outputs and thereby provide perception outputs to the prediction system 104.

In a simulation context, depending on the nature of the testing—and depending, in particular, on where the stack 100 is “sliced” for the purpose of testing—it may or may not be necessary to model the on-board sensor system 100. With higher-level slicing, simulated sensor data is not required therefore complex sensor modelling is not required.

The perception outputs from the perception system 102 are used by the prediction system 104 to predict future behaviour of external actors (agents), such as other vehicles in the vicinity of the AV.

Predictions computed by the prediction system 104 are provided to the planner 106, which uses the predictions to make autonomous driving decisions to be executed by the AV in a given driving scenario. The inputs received by the planner 106 would typically indicate a drivable area and would also capture predicted movements of any external agents (obstacles, from the AV's perspective) within the drivable area. The driveable area can be determined using perception outputs from the perception system 102 in combination with map information, such as an HD (high definition) map.

A core function of the planner 106 is the planning of trajectories for the AV (ego trajectories), taking into account predicted agent motion. This may be referred to as trajectory planning. A trajectory is planned in order to carry out a desired goal within a scenario. The goal could for example be to enter a roundabout and leave it at a desired exit; to overtake a vehicle in front; or to stay in a current lane at a target speed (lane following). The goal may, for example, be determined by an autonomous route planner (not shown).

The controller 108 executes the decisions taken by the planner 106 by providing suitable control signals to an on-board actor system 112 of the AV. In particular, the planner 106 plans trajectories for the AV and the controller 108 generates control signals to implement the planned trajectories. Typically, the planner 106 will plan into the future, such that a planned trajectory may only be partially implemented at the control level before a new trajectory is planned by the planner 106.

FIG. 1B shows a highly schematic overview of a testing paradigm for autonomous vehicles. An ADS/ADAS stack 100, e.g. of the kind depicted in FIG. 1A, is subject to repeated testing and evaluation in simulation, by running multiple scenario instances in a simulator 202, and evaluating the performance of the stack 100 (and/or individual subs-stacks thereof) in a test oracle 252. The output of the test oracle 252 is informative to an expert 122 (team or individual), allowing them to identify issues in the stack 100 and modify the stack 100 to mitigate those issues (S124). The results also assist the expert 122 in selecting further scenarios for testing (S126), and the process continues, repeatedly modifying, testing and evaluating the performance of the stack 100 in simulation. The improved stack 100 is eventually incorporated (S125) in a real-world AV 101, equipped with a sensor system 110 and an actor system 112. The improved stack 100 typically includes program instructions (software) executed in one or more computer processors of an on-board computer system of the vehicle 101 (not shown). The software of the improved stack is uploaded to the AV 101 at step S125. Step 125 may also involve modifications to the underlying vehicle hardware. On board the AV 101, the improved stack 100 receives sensor data from the sensor system 110 and outputs control signals to the actor system 112. Real-world testing (S128) can be used in combination with simulation-based testing. For example, having reached an acceptable level of performance though the process of simulation testing and stack refinement, appropriate real-world scenarios may be selected (S130), and the performance of the AV 101 in those real scenarios may be captured and similarly evaluated in the test oracle 252.

Scenarios can be obtained for the purpose of simulation in various ways, including manual encoding. The system is also capable of extracting scenarios for the purpose of simulation from real-world runs, allowing real-world situations and variations thereof to be re-created in the simulator 202.

FIG. 1C shows a highly schematic block diagram of a scenario extraction pipeline. Data 140 of a real-world run is passed to a ‘ground-truthing’ pipeline 142 for the purpose of generating scenario ground truth. The run data 140 could comprise, for example, sensor data and/or perception outputs captured/generated on board one or more vehicles (which could be autonomous, human-driven or a combination thereof), and/or data captured from other sources such external sensors (CCTV etc.). The run data is processed within the ground truthing pipeline 142, in order to generate appropriate ground truth 144 (trace(s) and contextual data) for the real-world run. As discussed, the ground-truthing process could be based on manual annotation of the ‘raw’ run data 142, or the process could be entirely automated (e.g. using offline perception method(s)), or a combination of manual and automated ground truthing could be used. For example, 3D bounding boxes may be placed around vehicles and/or other agents captured in the run data 140, in order to determine spatial and motion states of their traces. A scenario extraction component 146 receives the scenario ground truth 144, and processes the scenario ground truth 144 to extract a more abstracted scenario description 148 that can be used for the purpose of simulation. The scenario description 148 is consumed by the simulator 202, allowing multiple simulated runs (instances) to be performed. The simulated runs are variations of the original real-world run, with the degree of possible variation determined by the extent of abstraction. Ground truth 150 is provided for each simulated run.

Simulation Context

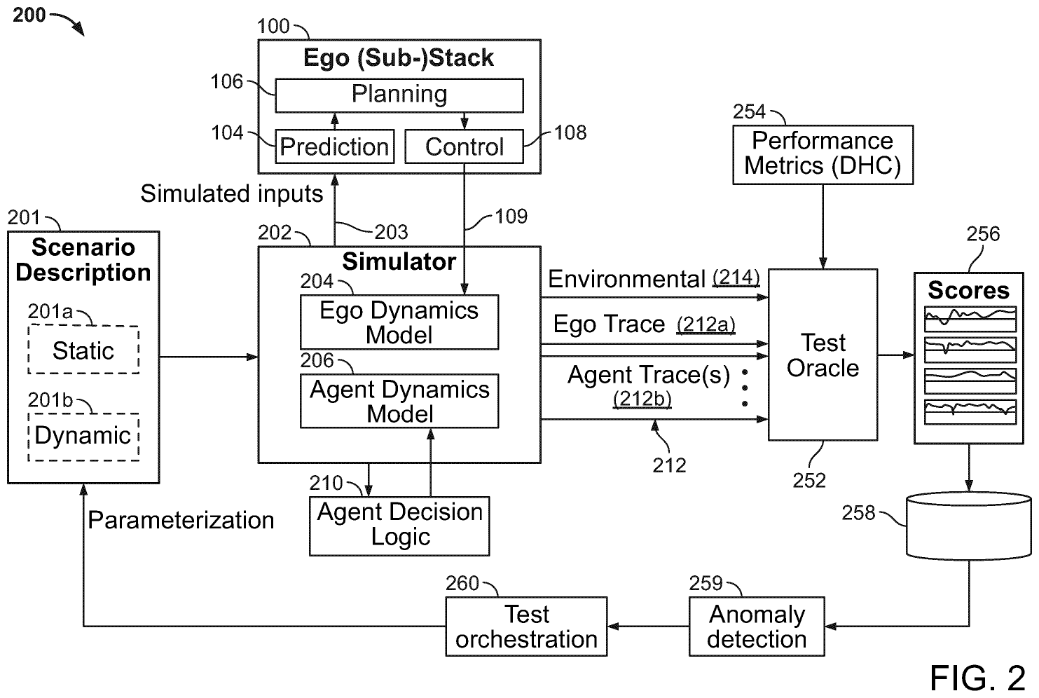

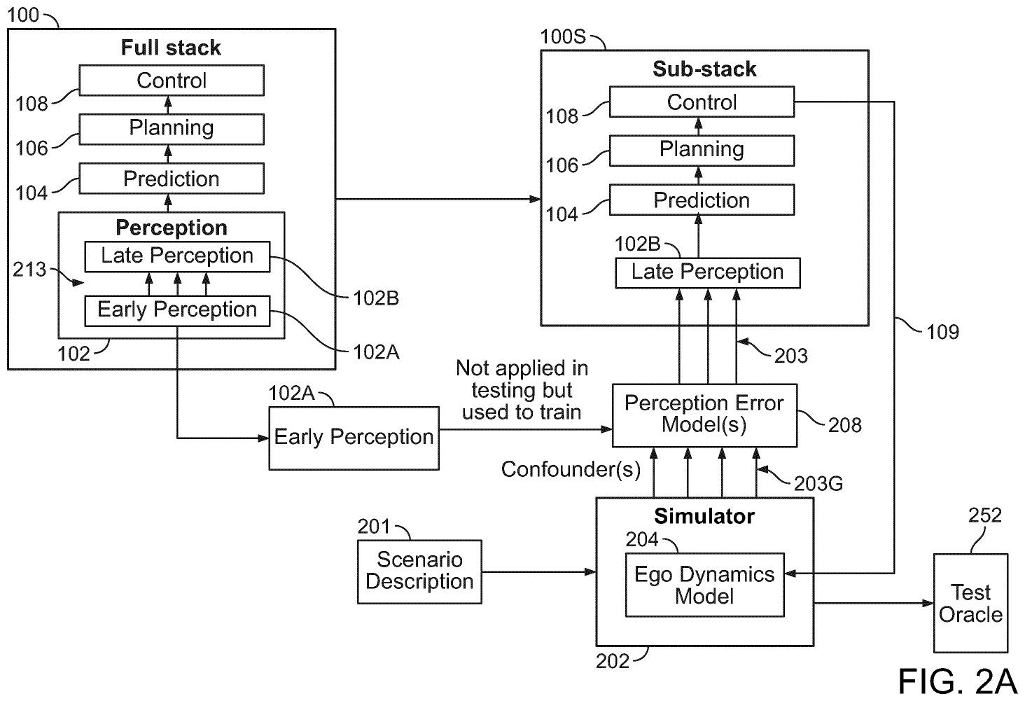

FIG. 2 shows a schematic block diagram of a testing pipeline 200. The testing pipeline 200 is shown to comprise a simulator 202 and a test oracle 252. The simulator 202 runs simulated scenarios for the purpose of testing all or part of an AV run time stack, and the test oracle 253 evaluates the performance of the stack (or sub-stack) on the simulated scenarios. The following description refers to the stack of FIG. 1A by way of example. However, the testing pipeline 200 is highly flexible and can be applied to any stack or sub-stack operating at any level of autonomy.

The idea of simulation-based testing is to run a simulated driving scenario that an ego agent must navigate under the control of a stack (or sub-stack) being tested. Typically, the scenario includes a static drivable area (e.g. a particular static road layout) that the ego agent is required to navigate in the presence of one or more other dynamic agents (such as other vehicles, bicycles, pedestrians etc.). Simulated inputs feed into the stack under testing, where they are used to make decisions. The ego agent is, in turn, caused to carry out those decisions, thereby simulating the behaviour of an autonomous vehicle in those circumstances.

Simulated inputs 203 are provided to the stack under testing. “Slicing” refers to the selection of a set or subset of stack components for testing. This, in turn, dictates the form of the simulated inputs 203.

By way of example, FIG. 2 shows the prediction, planning and control systems 104, 106 and 108 within the AV stack 100 being tested. To test the full AV stack of FIG. 1A, the perception system 104 could also be applied during testing. In this case, the simulated inputs 203 would comprise synthetic sensor data that is generated using appropriate sensor model(s) and processed within the perception system 102 in the same way as real sensor data. This requires the generation of sufficiently realistic synthetic sensor inputs (such as photorealistic image data and/or equally realistic simulated lidar/radar data etc.). The resulting outputs of the perception system 102 would, in turn, feed into the higher-level prediction and planning systems 104, 106.

By contrast, so-called “planning-level” simulation would essentially bypass the perception system 102. The simulator 202 would instead provide simpler, higher-level inputs 203 directly to the prediction system 104. In some contexts, it may even be appropriate to bypass the prediction system 104 as well, in order to test the planner 106 on predictions obtained directly from the simulated scenario.

Between these extremes, there is scope for many different levels of input slicing, e.g. testing only a subset of the perception system, such as “later” perception components, i.e., components such as filters or fusion components which operate on the outputs from lower-level perception components (such as object detectors, bounding box detectors, motion detectors etc.).

By way of example only, the description of the testing pipeline 200 makes reference to the runtime stack 100 of FIG. 1A. As discussed, it may be that only a sub-stack of the run-time stack is tested, but for simplicity, the following description refers to the AV stack 100 throughout. In FIG. 2, reference numeral 100 can therefore denote a full AV stack or only sub-stack depending on the context. For the avoidance of doubt, the term stack may be used in relation to a full stack 100 of the kind shown in FIG. 1A, but also a more limited sub-stack (such as the planner 106) in isolation.

Whatever form they take, the simulated inputs 203 are used (directly or indirectly) as a basis for decision-making by the planner 108.

The controller 108, in turn, implements the planner's decisions by outputting control signals 109. In a real-world context, these control signals would drive the physical actor system 112 of AV. In simulation, an ego vehicle dynamics model 204 is used to translate the resulting control signals 109 into realistic motion of the ego agent within the simulation, thereby simulating the physical response of an autonomous vehicle to the control signals 109.

Alternatively, a simpler form of simulation assumes that the ego agent follows each planned trajectory exactly. This approach bypasses the control system 108 (to the extent it is separable from planning) and removes the need for the ego vehicle dynamic model 204. This may be sufficient for testing certain facets of planning.

To the extent that external agents exhibit autonomous behaviour/decision making within the simulator 202, some form of agent decision logic 210 is implemented to carry out those decisions and determine agent behaviour within the scenario. The agent decision logic 210 may be comparable in complexity to the ego stack 100 itself or it may have a more limited decision-making capability. The aim is to provide sufficiently realistic external agent behaviour within the simulator 202 to be able to usefully test the decision-making capabilities of the ego stack 100. In some contexts, this does not require any agent decision making logic 210 at all (open-loop simulation), and in other contexts useful testing can be provided using relatively limited agent logic 210 such as basic adaptive cruise control (ACC). One or more agent dynamics models 206 may be used to provide more realistic agent behaviour.

A simulation of a driving scenario is run in accordance with a scenario description 201, having both static and dynamic layers 201a, 201b.

The static layer 201a defines static elements of a scenario, which would typically include a static road layout.

The dynamic layer 201b defines dynamic information about external agents within the scenario, such as other vehicles, pedestrians, bicycles etc. The extent of the dynamic information provided can vary. For example, the dynamic layer 201b may comprise, for each external agent, a spatial path to be followed by the agent together with one or both of motion data and behaviour data associated with the path. In simple open-loop simulation, an external actor simply follows the spatial path and motion data defined in the dynamic layer that is non-reactive i.e. does not react to the ego agent within the simulation. Such open-loop simulation can be implemented without any agent decision logic 210. However, in closed-loop simulation, the dynamic layer 201b instead defines at least one behaviour to be followed along a static path (such as an ACC behaviour). In this case, the agent decision logic 210 implements that behaviour within the simulation in a reactive manner, i.e. reactive to the ego agent and/or other external agent(s). Motion data may still be associated with the static path but in this case is less prescriptive and may for example serve as a target along the path. For example, with an ACC behaviour, target speeds may be set along the path which the agent will seek to match, but the agent decision logic 110 might be permitted to reduce the speed of the external agent below the target at any point along the path in order to maintain a target headway from a forward vehicle.

The output of the simulator 202 for a given simulation includes an ego trace 212a of the ego agent and one or more agent traces 212b of the one or more external agents (traces 212).

A trace is a complete history of an agent's behaviour within a simulation having both spatial and motion components. For example, a trace may take the form of a spatial path having motion data associated with points along the path such as speed, acceleration, jerk (rate of change of acceleration), snap (rate of change of jerk) etc.

Additional information is also provided to supplement and provide context to the traces 212. Such additional information is referred to as “environmental” data 214 which can have both static components (such as road layout) and dynamic components (such as weather conditions to the extent they vary over the course of the simulation). To an extent, the environmental data 214 may be “passthrough” in that it is directly defined by the scenario description 201 and is unaffected by the outcome of the simulation. For example, the environmental data 214 may include a static road layout that comes from the scenario description 201 directly. However, typically the environmental data 214 would include at least some elements derived within the simulator 202. This could, for example, include simulated weather data, where the simulator 202 is free to change weather conditions as the simulation progresses. In that case, the weather data may be time-dependent, and that time dependency will be reflected in the environmental data 214.

The test oracle 252 receives the traces 212 and the environmental data 214, and scores those outputs in the manner described below. The scoring is time-based: for each performance metric, the test oracle 252 tracks how the value of that metric (the score) changes over time as the simulation progresses. The test oracle 252 provides an output 256 comprising a score-time plot for each performance metric, as described in further detail later. The metrics 254 are informative to an expert and the scores can be used to identify and mitigate performance issues within the tested stack 100. The test oracle 252 also provides an overall (aggregate) result for the scenario (e.g. overall pass/fail). The output 256 of the test oracle 252 is stored in a test database 258.

Perception Error Models

FIG. 2A illustrates a particular form of slicing and uses reference numerals 100 and 100S to denote a full stack and sub-stack respectively. It is the sub-stack 100S that would be subject to testing within the testing pipeline 200 of FIG. 2.

A number of “later” perception components 102B form part of the sub-stack 100S to be tested and are applied, during testing, to simulated perception inputs 203. The later perception components 102B could, for example, include filtering or other fusion components that fuse perception inputs from multiple earlier perception components.

In the full stack 100, the later perception component 102B would receive actual perception inputs 213 from earlier perception components 102A. For example, the earlier perception components 102A might comprise one or more 2D or 3D bounding box detectors, in which case the simulated perception inputs provided to the late perception components could include simulated 2D or 3D bounding box detections, derived in the simulation via ray tracing. The earlier perception components 102A would generally include component(s) that operate directly on sensor data.

With this slicing, the simulated perception inputs 203 would correspond in form to the actual perception inputs 213 that would normally be provided by the earlier perception components 102A. However, the earlier perception components 102A are not applied as part of the testing, but are instead used to train one or more perception error models 208 that can be used to introduce realistic error, in a statistically rigorous manner, into the simulated perception inputs 203 that are fed to the later perception components 102B of the sub-stack 100 under testing.

Such perception error models may be referred to as Perception Statistical Performance Models (PSPMs) or, synonymously, “PRISMs”. Further details of the principles of PSPMs, and suitable techniques for building and training them, may be bound in International Patent Application Nos. PCT/EP2020/073565, PCT/EP2020/073562, PCT/EP2020/073568, PCT/EP2020/073563, and PCT/EP2020/073569, each of which is incorporated herein by reference in its entirety. The idea behind PSPMs is to efficiently introduce realistic errors into the simulated perception inputs provided to the sub-stack 100S (i.e. that reflect the kind of errors that would be expected were the earlier perception components 102A to be applied in the real-world). In a simulation context, “perfect” ground truth perception inputs 203G are provided by the simulator, but these are used to derive more realistic perception inputs 203 with realistic error introduced by the perception error models(s) 208.

As described in the aforementioned reference, a PSPM can be dependent on one or more variables representing physical condition(s) (“confounders”), allowing different levels of error to be introduced that reflect different possible real-world conditions. Hence, the simulator 202 can simulate different physical conditions (e.g. different weather conditions) by simply changing the value of a weather confounder(s), which will, in turn, change how perception error is introduced.

The later perception components 102b within the sub-stack 100S process the simulated perception inputs 203 in exactly the same way as they would process the real-world perception inputs 213 within the full stack 100, and their outputs, in turn, drive prediction, planning and control. Alternatively, PSPMs can be used to model the entire perception system 102, including the late perception components 208.

Test Oracle Rules

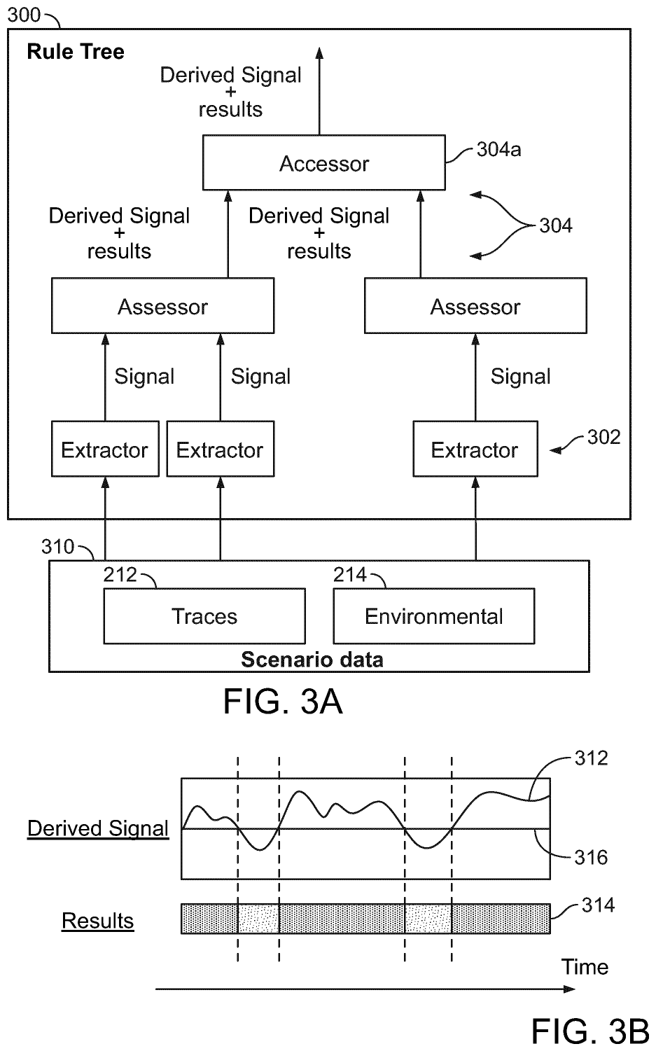

Trajectory/trace evaluation rules are constructed within the test oracle 252 as computational graphs (rule trees). FIG. 3A shows an example of a rule tree 300 constructed from a combination of extractor nodes (leaf objects) 302 and assessor nodes (non-leaf objects) 304. Each extractor node 302 extracts a time-varying numerical (e.g. floating point) signal (score) from a set of scenario data 310. The scenario data 310 may be referred to as the scenario “ground truth” in this context. The scenario data 310 has been obtained by deploying a trajectory planner (such as the planner 106 of FIG. 1A) in a real or simulated scenario, and is shown to comprise ego and agent traces 212 as well as environmental data 214. In the simulation context of FIG. 2 or 2A, the scenario ground truth 300 is provided in the output of the simulator 202. Unless otherwise indicated, the term “rule tree” herein refers to the computational graph that is configured to implement a given rule (the term “rule graph” is used later to mean a graphical representation of aggregate test results over multiple scenario parameterizations).

Each assessor node 304 is shown to have at least one child object (node), where each child object is one of the extractor nodes 302 or another one of the assessor nodes 304. Each assessor node receives output(s) from its child node(s) and applies an assessor function to those output(s). The output of the assessor function is a time-series of categorical results. The following examples consider simple binary pass/fail results, but the techniques can be readily extended to non-binary results. Each assessor function assesses the output(s) of its child node(s) against a predetermined atomic rule. Such rules can be flexibly combined in accordance with a desired safety model.

In addition, each assessor node 304 derives a time-varying numerical signal from the output(s) of its child node(s), which is related to the categorical results by a threshold condition (see below).

A top-level root node 304a is an assessor node that is not a child node of any other node. The top-level node 304a outputs a final sequence of results, and its descendants (i.e. nodes that are direct or indirect children of the top-level node 304a) provide the underlying signals and intermediate results.

FIG. 3B visually depicts an example of a derived signal 312 and a corresponding time-series of results 314 computed by an assessor node 304. The results 314 are correlated with the derived signal 312, in that a pass result is returned when (and only when) the derived signal exceeds a failure threshold 316. As will be appreciated, this is merely one example of a threshold condition that relates a time-sequence of results to a corresponding signal.

Signals extracted directly from the scenario ground truth 310 by the extractor nodes 302 may be referred to as “raw” signals, to distinguish from “derived” signals computed by assessor nodes 304. Results and raw/derived signals may be discretised in time.

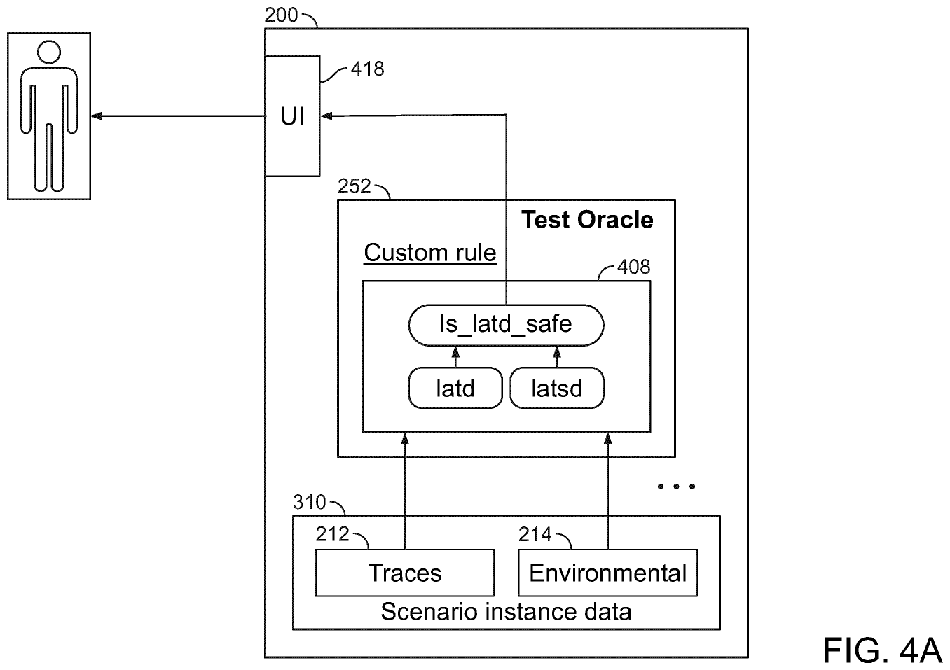

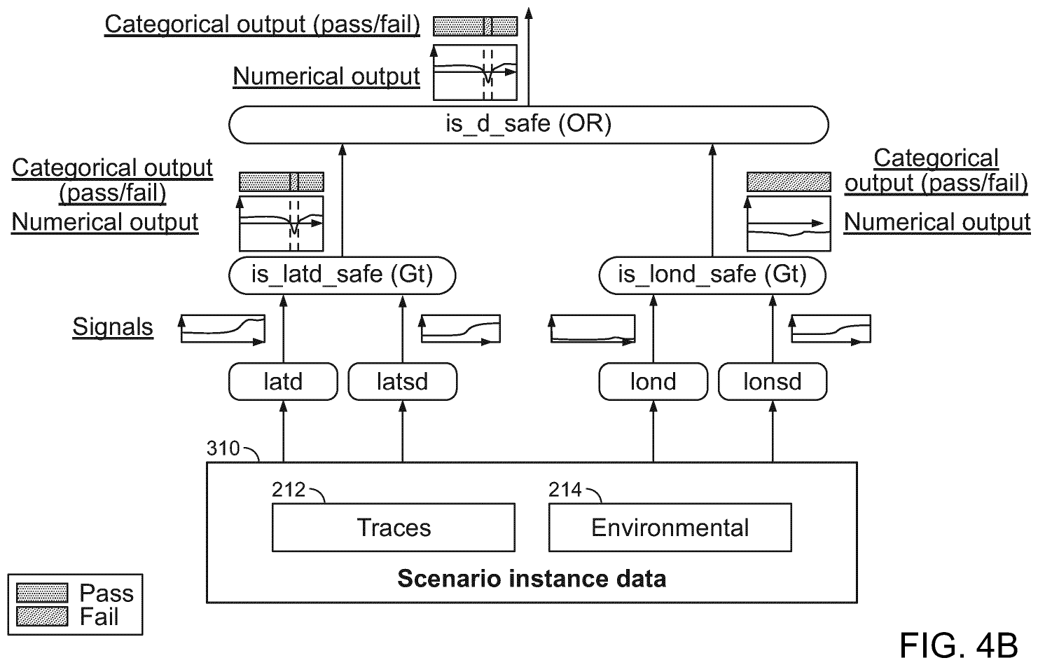

FIG. 4A shows an example of a rule tree implemented within the testing platform 200.

The following examples consider rules that are formulated using combinations of atomic logic predicates. Examples of basic atomic predicates include elementary logic gates (OR, AND etc.), and logical functions such as “greater than”, (Gt(a,b)) (which returns true when a is greater than b, and false otherwise).

A Gt function is to implement a safe lateral distance rule between an ego agent and another agent in the scenario (having agent identifier “other_agent_id”). Two extractor nodes (latd, latsd) apply LateralDistance and LateralSafeDistance extractor functions respectively. Those functions operate directly on the scenario ground truth 310 to extract, respectively, a time-varying lateral distance signal (measuring a lateral distance between the ego agent and the identified other agent), and a time-varying safe lateral distance signal for the ego agent and the identified other agent. The safe lateral distance signal could depend on various factors, such as the speed of the ego agent and the speed of the other agent (captured in the traces 212), and environmental conditions (e.g. weather, lighting, road type etc.) captured in the environmental data 214.

An assessor node (is_latd_safe) is a parent to the latd and latsd extractor nodes, and is mapped to the Gt atomic predicate. Accordingly, when the rule tree 408 is implemented, the is_latd_safe assessor node applies the Gt function to the outputs of the latd and latsd extractor nodes, in order to compute a true/false result for each timestep of the scenario, returning true for each time step at which the latd signal exceeds the latsd signal and false otherwise. In this manner, a “safe lateral distance” rule has been constructed from atomic extractor functions and predicates; the ego agent fails the safe lateral distance rule when the lateral distance reaches or falls below the safe lateral distance threshold. As will be appreciated, this is a very simple example of a custom rule. Rules of arbitrary complexity can be constructed according to the same principles.

The test oracle 252 applies the custom rule tree 408 to the scenario ground truth 310, and provides the results via a user interface (UI) 418.

FIG. 4B shows an example of a custom rule tree that includes a lateral distance branch corresponding to that of FIG. 4A. Additionally, the rule tree includes a longitudinal distance branch, and a top-level OR predicate (safe distance node, is_d_safe) to implement a safe distance metric. Similar to the longitudinal distance branch, the lateral distance brand extracts lateral distance and lateral distance threshold signals from the scenario data (extractor nodes lond and lonsd respectively), and a longitudinal safety assessor node (is_lond_safe) outputs true TRUE when the lateral distance is above the safe lateral distance threshold. The top-level OR node returns TRUE when one or both of the lateral and longitudinal distances is safe (below the applicable threshold), and FALSE if neither is safe. In this context, it is sufficient for only one of the distances to exceed the safety threshold (e.g. if two vehicles are driving in adjacent lanes, their longitudinal separation is zero or close to zero when they are side-by-side; but that situation is not unsafe if those vehicles have sufficient lateral separation).

The numerical output of the top-level node could, for example, be a time-varying robustness score.

Different rule trees can be constructed, e.g. to implement different rules of a given safety model, to implement different safety models, or to apply rules selectively to different scenarios (in a given safety model, not every rule will necessarily be applicable to every scenario; with this approach, different rules or combinations of rules can be applied to different scenarios). Within this framework, rules can also be constructed for evaluating comfort (e.g. based on instantaneous acceleration and/or jerk along the trajectory), progress (e.g. based on time taken to reach a defined goal) etc.

The above examples consider simple logical predicates evaluated on results or signals at a single time instance, such as OR, AND, Gt etc. However, in practice, it may be desirable to formulate certain rules in terms of temporal logic.

Hekmatnej ad et al., “Encoding and Monitoring Responsibility Sensitive Safety Rules for Automated Vehicles in Signal Temporal Logic” (2019), MEMOCODE ′19: Proceedings of the 17th ACM-IEEE International Conference on Formal Methods and Models for System Design (incorporated herein by reference in its entirety) discloses a signal temporal logic (STL) encoding of the RSS safety rules. Temporal logic provides a formal framework for constructing predicates that are qualified in terms of time. This means that the result computed by an assessor at a given time instant can depend on results and/or signal values at another time instant(s).

For example, a requirement of the safety model may be that an ego agent responds to a certain event within a set time frame. Such rules can be encoded in a similar manner, using temporal logic predicates within the rule tree.

In the above examples, the performance of the stack 100 is evaluated at each time step of a scenario. An overall test result (e.g. pass/fail) can be derived from this—for example, certain rules (e.g. safety-critical rules) may result in an overall failure if the rule is failed at any time step within the scenario (that is, the rule must be passed at every time step to obtain an overall pass on the scenario). For other types of rule, the overall pass/fail criteria may be “softer” (e.g. failure may only be triggered for a certain rule if that rule is failed over some number of sequential time steps), and such criteria may be context dependent.

Test Orchestration

A simulated scenario may have one or more configurable numerical parameters (variables) applicable to element(s) of the static and/or dynamic layers 201a, 201b. The parameter(s) may, for example, form part of the scenario description 201, and their chosen value(s) form part of the input to the simulator 202. A “parameterization” of a scenario refers to a particular (combination of) parameter value(s), corresponding to a point in a “parameter space” of the scenario (each configurable parameter defines a dimension of the parameter space). The following examples consider scenarios with multiple configurable parameters, but it will be appreciated that the description applies equally to the single parameter case. Note, the terms parameter space and scenario space are used interchangeably herein.

A scenario instance refers to an instantiation of a scenario in the simulator 202 with a particular parameterization. Multiple instances of a given scenario may be run with different parameterizations in the manner described above, with the test oracle 252 computing a set of test results for each scenario instance as described.

Certain scenarios may have a relatively small number of salient parameters. For example, in a cut-in scenario, in which the ego agent is driving along an ego lane, and is required to respond to another vehicle moving into the ego lane ahead of it (a cut-in action by the other vehicle), the parameters may comprise a cut in distance and a velocity (speed) of the other vehicle relative to the ego vehicle. By varying the cut in distance and the relative speed, different instances of the cut in scenario can be explored with different values of the salient parameters.

The following examples consider a 2D parameter space (2 configurable parameters) for the sake of illustration. It will be appreciated that the described techniques can be extended to a parameter space of any number of dimensions.

Returning to FIG. 2, a test orchestration component 260 is shown having an input connected to the output of an anomaly detection component 259, which in turn is shown having an input connected to the test database 258 for accessing the outputs 256 of the test oracle 252. The test orchestration component 260 formulates an appropriate strategy for exploring the parameter space of a scenario (scenario exploration strategy). The scenario exploration strategy is implemented in an iterative fashion, with the results obtained by the test oracle 252 at each iteration informing the strategy in the next iteration. The strategy involves testing different parameterizations (combinations of parameter values) in each iteration, evaluating the simulator output for each parameterization in the test oracle 252, and using the output of the test oracle 252 to select further parameterizations to explore in the next iteration. The aim is to target “interesting” regions of the scenario space in the subsequent iteration(s). Anomalous parameterizations—whose test results differ from those of their neighbours—are of particular interest, but the techniques can be extended to other forms of target parameterization (see below).

The strategy aims to maximize the saliency of the results whilst minimizing the number of scenario instances that need to be run in order to adequately explore the scenario parameter space. Running even a single scenario instance for a given parameterization requires significant computational resources. In many situations, small changes to the scenario parameters will not have a major impact on the performance of the stack 100 or the results computed by the test oracle 252. Therefore, a relatively “coarse” exploration may be sufficient for most (if not all) of the scenario space. However, from time to time, anomalous scenario instances may occur that merit further investigation. Whether or not a scenario instance is “anomalous” is determined based on the output of the test oracle 252 for that scenario instance, in relation to the outputs computed by the test oracle for neighbouring scenario instances in the parameter space. In other words, a scenario instance may be classed as anomalous if its test results, as provided by the test oracle 252, deviate significantly from those of other scenario instances with similar parameterizations. When an anomalous scenario instance is detected based on the outputs of the test oracle 252, a more “fine grained” exploration of a surrounding region of the parameter space is instigated in response.

“Progressive feedback” from the test results is provided in the following manner.

A set of simulations are run, that explores a scenario space. The test oracle 252 provides aggregated summaries of the results of those simulations against multiple trajectory evaluation rules.

For certain rules, rule failures might highlight some small anomalies in the results, such as parameterizations that have resulted in failure when a majority of similar (neighbouring) parameterizations do not. Anomalous results flag interesting regions of the parameter space to explore further.

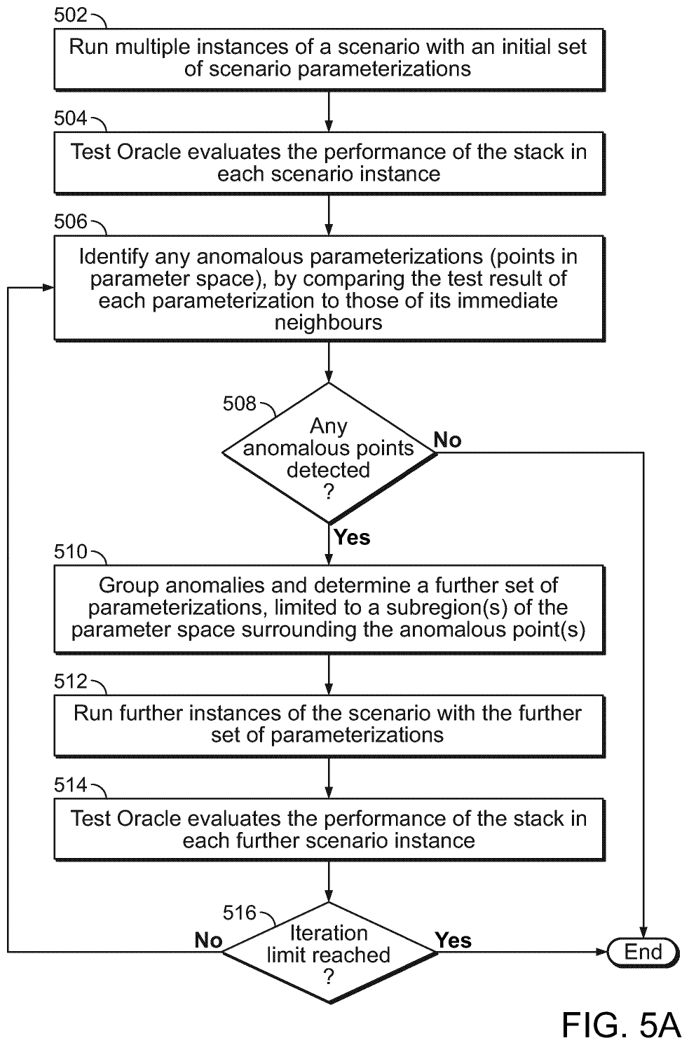

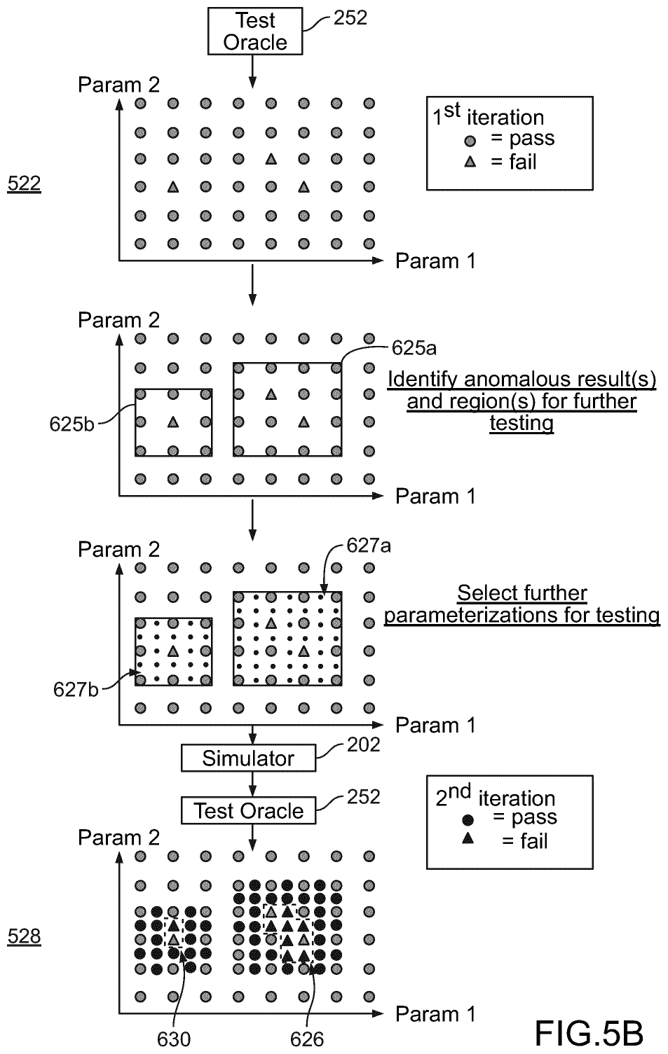

FIG. 5A shows a flow chart for a scenario exploration method implemented within the testing platform. FIG. 5B shows example outputs that might be obtained at various steps of the method. A set of results is generated in the form of a set of parameterizations each having a performance evaluation result (e.g. overall pass/fail or pass fail on a particular rule or subset of rules) assigned thereto. The set of results is updated at each iteration to include additional parameterisations that have been evaluated in that iteration.

At step 502, in a first iteration of the method, multiple instances of a scenario are run with an initial set of parameterizations (different combinations of parameters, corresponding to multiple points in the parameter space). The scenario parameterizations are uniformly spaced in the parameters space, but are relatively “coarse” (low density).

At step 504, an initial set of test results is obtained from the test oracle 252 for the initial set of parameterizations. The test results are computed by the test oracle 252 evaluating the traces 212 for each scenario instance against an appropriate set of trajectory evaluation rules.

FIG. 5B shows an example set of an initial set of aggregate test results 522 that might be obtained from the test oracle 252 at step 504, in respect of a particular trajectory evaluation rule. In this case, a simple pass/fail result is obtained for each parameterization in the 2D parameter space defined by “Param 1” and “Param 2”. In this example, the majority of parameterizations result in a “pass” for the rule in question, with a handful of isolated parameterizations resulting in “failures”.

At step 506, anomaly detection is applied to the test results obtained at step 504.

To detect anomalous parameterizations, the aggregated test result for each parameterization is compared with the results of its eight direct neighbours in the 2D parameter space (with e.g. three parameters, there would be a cuboid of neighbours to check against). For a given parameterization, a subset of neighbouring parameterizations (neighbours) is selected in the current set of results based on proximity to the given parameterization in the scenario space. The performance evaluation result assigned to the given parameterization is compared to the corresponding results assigned to the subset of neighbouring parameterizations.

A point is classed as anonymous if its test result differs from that of at least N of its closest neighbours. For example, with N=8, a point is classed as anomalous if its aggregate test results differ from the aggregate test results of at least eight of its neighbours. This is merely an example, and different values of N may be used. A value of N in the range of 5 to 8 would typically be suitable for anomaly detection in 2D scenario space. In some implementations, N could be a configurable parameter of the system. It will be appreciated that this is merely one example of a suitable anomaly detection technique. Other sequences can be used to identify anomalous (or, more generally, “interesting” points in the parameter space, based on a comparison of their test results with those of neighbouring points (immediate neighbours and/or other nearby points) in the parameter space).

In some implementations, both isolated passes and isolated failures may be classed an anomalous. In other implementations, the method may be restricted to identifying only anomalous failures.

If no anomalies are detected (508), the method terminates; otherwise, at step 510, the method groups the detected anomalies and determines an additional set of parameterizations to be explored in the system. The additional parameterizations are limited to subregion(s) of the parameter space surrounding the detected anomaly or anomalies.

FIG. 5B shows an example of a possible outcome at step 510. In this example, three isolated failure results have been identified as anomalous based on their respective neighbouring points, with two subregions 625a, 625b of the parameter space chosen for further exploration as a result. Further points (parameterizations) 627a, 627b to be tested are selected within the subregions 625a, 625b (shown as small black circles). As can be seen, these have a higher density (smaller spacing) in the parameter space than the initial set of parameterizations, but are limited to the subregions 625a, 625b surrounding the anomalous points.

At step 512, further instances of the scenario are run with the further parameterizations determined at step 510.

At step 514, the results of the further simulations are evaluated by the test oracle 252, to obtain an aggregate (e.g. overall pass/fail result) for each additional parameterization.

The final step is to run these new targeted runs, and then get results for those, which can be overlaid on top of the original set.

FIG. 5B shows an example of further test results 528 that might be obtained at step 514. The subregions 6271, 627b have now been explored with increased “resolution” (increased density of point in the parameter space) relative to the initial iteration. In this case, the outcome is a relatively large region 629 of failures that are no longer classed as anomalous (based on their new direct neighbours), as well as a small number of isolated failures 630 that are still anomalous (notwithstanding their new direct neighbours).

Steps 512 and 514 are instigated automatically in this example, in response to the detection of one or more anomalies at step 506. The method repeats in an iterative manner, until either no more anomalies are detected, or other terminating condition is met, such as reaching a set maximum number of iterations. As shown in FIG. 5A, assuming the iteration limit has not been reached (516), steps 508-514 are repeated for the additional parameterizations.

Steps 512 and 514 could also be instigated manually. Preferably, this requires minimal (e.g. “one-click”) user input, with coordination of the further simulations handled autonomously by the test orchestration component 230. In this case, the user simply confirms that the system should proceed with a further iteration(s), and everything is automated from that point on.

Alternatively, the new parameterizations could be provided to the user, for them to manually instigate the further simulations. The processing of identifying those new parametrizations is automatic, as described herein.

Although sequential steps are depicted in FIG. 5A, this is merely illustrative. Certain steps may be performed in parallel, e.g. later instances may be run in the simulator as earlier instances are evaluated in the test oracle 252. The method can be performed over any time scale, with test results computed by the test oracle 252 stored in the test database 258 for use at any later time.

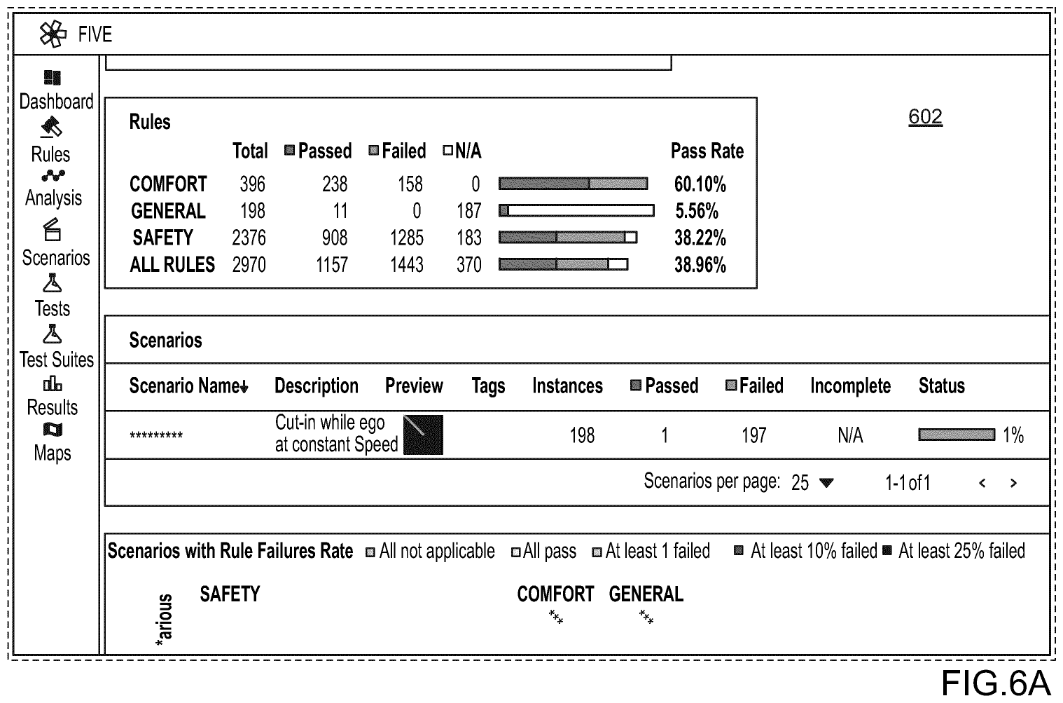

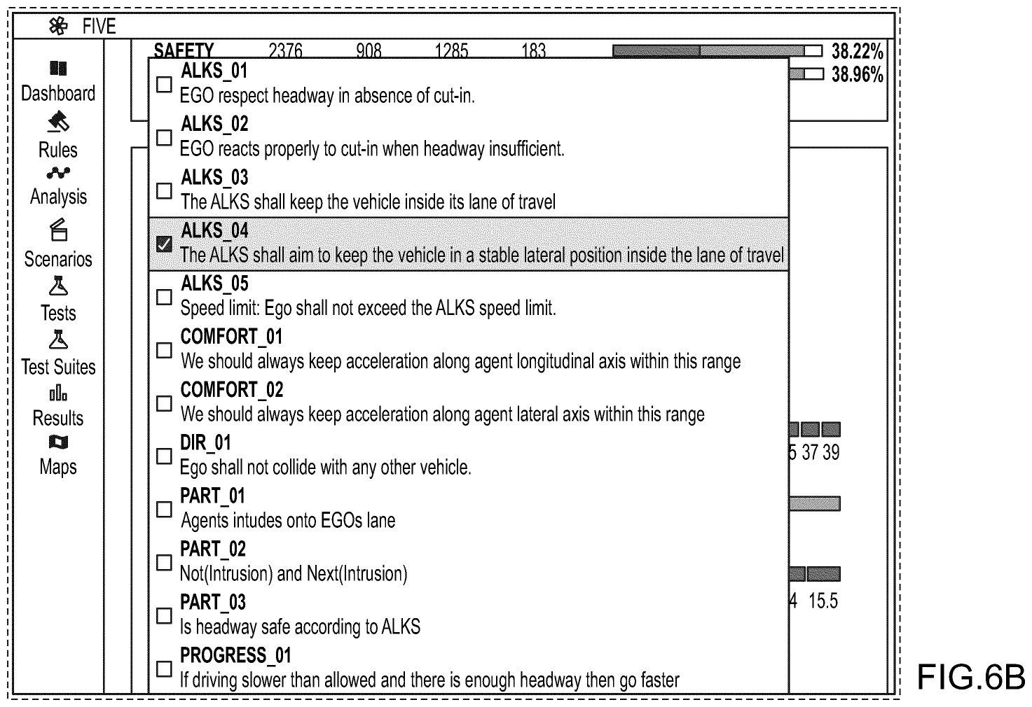

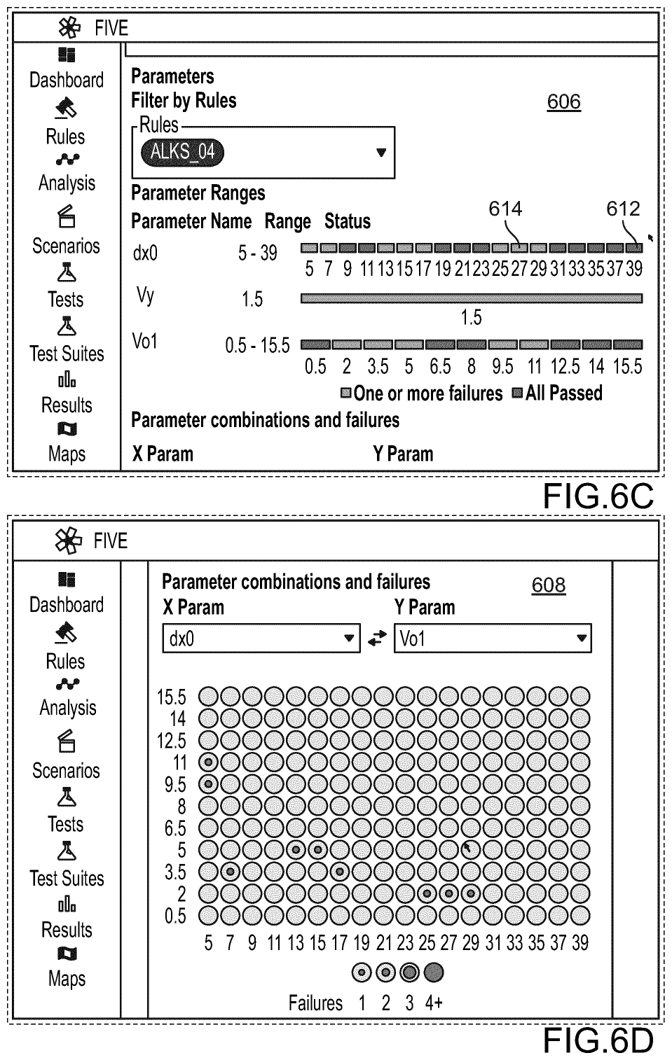

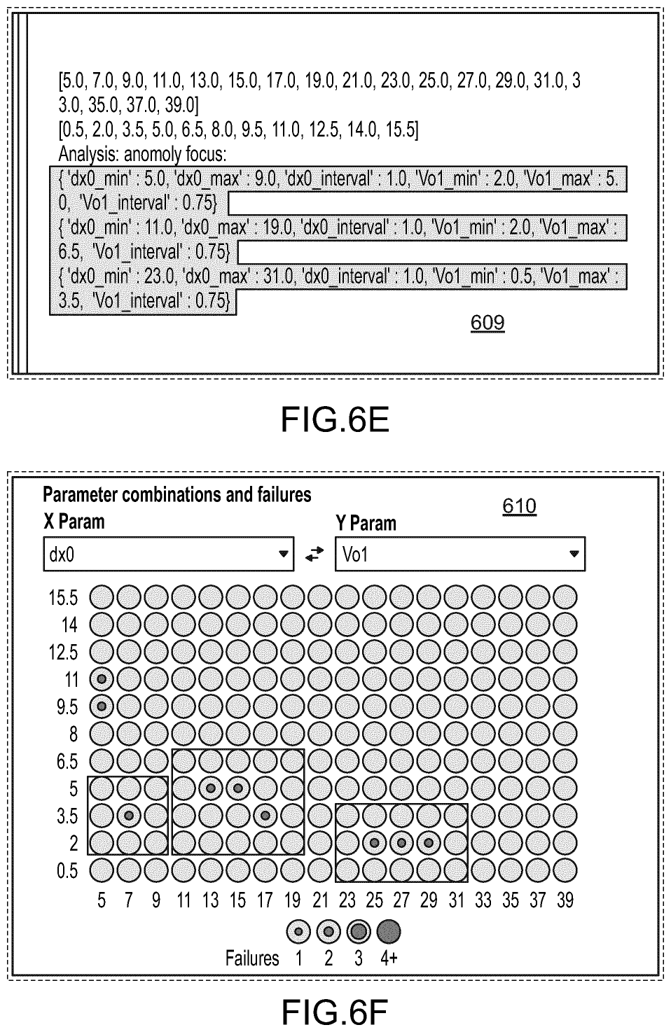

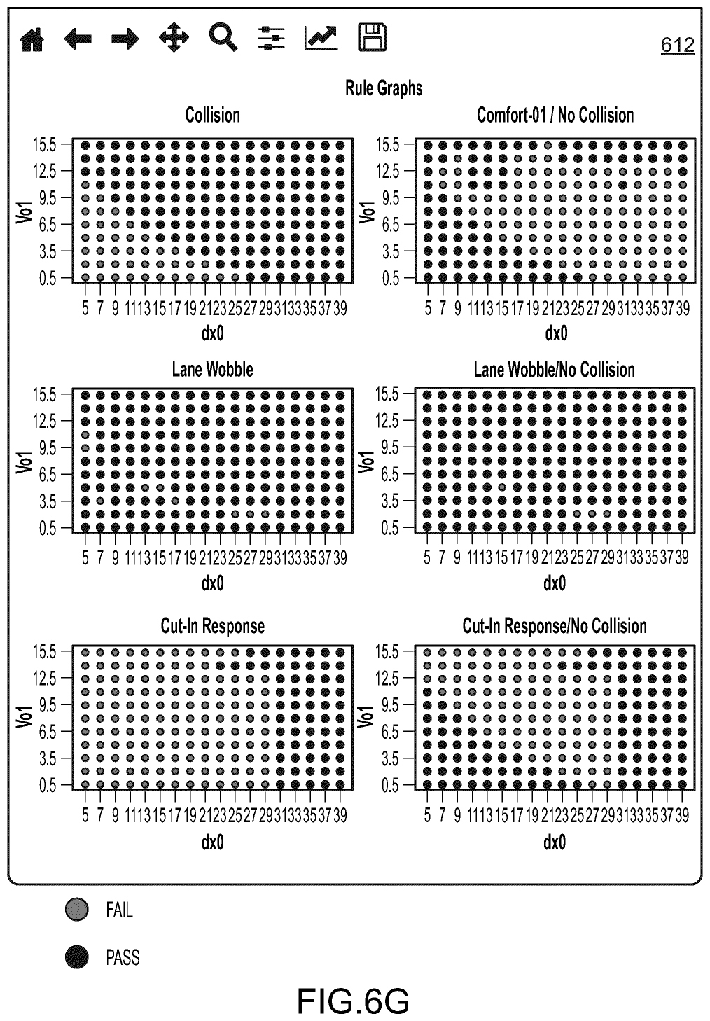

FIGS. 6A-6G show views of an example user interface that may be provided to explore the results.

FIG. 6A shows a first view 602 of a dashboard for a particular scenario, to which various rule types apply (safety, comfort, general).

FIG. 6B shows a second view 604. in which an example of a trajectory evaluation rule has been selected for the scenario from multiple trajectory evaluation rules.

FIG. 6C shows a third view 606, in which test results for three configurable numerical parameters of the scenario (dx0, Vy, Vo0) are visible. The following examples consider an exploration of a 2D scenario space defined by dx0 and Vo1. Pass/fail results are distinguished at the GUI using e.g. colour coding. By way of example, reference numeral 612 denotes a pass result, whilst reference numeral 614 denotes a fail.

FIG. 6D shows a fourth view 608 of an initial “rule graph” for the scenario; that is, a graphical representation of the test results obtained for the initial parameterizations of (dx0, Vo1). In this example, the parameterizations are spaced by an interval of 2 in the dx0 dimension, and 1.5 in the Vo1 dimension.

FIG. 6E shows a set of results 609 of anomaly detection applied to the test results. As can be seen, as well as automatically identifying further regions of the subspace to explore, new, narrower intervals for dx0 and Vo1 have been computed (1 and 0.75 respectively).

FIG. 6F shows a fifth view 610 that graphically depicts anomalous regions that have been identified by applying the above techniques. As can be seen, neighbouring anomalous points have been grouped together: there are seven anomalous points in the scenario space, grouped into three regions (subspaces). Points with pass outcomes are shown in green, whilst points with failure outcomes are shown in red.

FIG. 6G shows a sixth view 612 in which example rule graphs for different rules are visible. In this example, the middle row of rule graphs contains anomalous failure results, whilst the top and bottom most rows exhibit larger failure regions.

Whilst the above considers anomaly detection, the same techniques can also be used to detect and explore “edges” between different regions of the parameter space e.g. between larger pass/fail regions. Edge detection could be implemented by reducing the number of neighbours N that are required to have a result difference with (in 2D space, the criterion for a boundary line might be more in the range of 3-6 out of the possible 8 neighbours being different). Detectable edges can be seen in the two topmost and two bottommost rule graphs of FIG. 6G, between the relatively large pass and failure regions of the parameter space.

With regards to anomaly detection, other form(s) of anomaly detection can be applied to the test results within the scenario space, as an alternative or in addition to that/those described above.

Anomaly detection can be applied to the output of a single rule (as in the above examples), but could also take into account multiple rules.

For example, the output from multiple rules may be used in order to find anomalies, e.g. in a way that respects relative importance of rules. For example, a first “brake for pedestrian” rule that requires the ego agent to apply emergency braking e.g. when a pedestrian steps out onto the road, and a second rule for comfortable deceleration may be implemented in the platform. In that case, the safety-critical braking rule takes precedence over the secondary comfort rule. The analysis might only find an anomaly if there were any ‘comfortable deceleration failures’ when ego agent was not ‘braking for pedestrians’. One way to implement this would be to make overall failure on the comfortable acceleration rule dependent on the emergency braking rule (and/or any other higher priority rules)—a parameterization is only classed as a failure if the comfort rule is breached at a time when no higher priority rule takes precedence. Anomalous failures on the comfort rules can then be detected in the matter described above.

In the examples above, multiple scenario instances are run based on the same scenario description 201 but with different value(s) of its variable(s). However, the present techniques can be implemented in other ways. For example, in step 502 of the method, the multiple parameterizations could instead be hard-coded in multiple scenario descriptions (rather than encoding the parameter(s) as variable(s)). At the anomaly detection step 506, it is immaterial how the initial scenarios have been generated. What is germane is the ability to map different parameterizations to particular test results, in order to generate further scenario instances within the region(s) of the scenario space of interest. For example, the initial test-run of step 502 might use a manually-created scenario suite (with hard coded values instead of variables), e.g. of several hundred or thousand hard-coded versions of a scenario. The anomaly detection would still work in the same way, identifying anomalies and useful new scenarios to create. It should be understood that the term “parameter” is used in a broad sense to mean a characteristic of a scenario, and does not imply any particular implementation at the level of the code or hardware. A parameterization simply means a particular choice of characteristic(s) and does not imply any particular encoding of that choice. The terminology “running multiple scenario instances with multiple parameterizations” and the like encompasses the case where a scenario description has one or more variables and the multiple instances are run with different (combinations of) value(s) of those variables, but also the case where multiple versions of the scenario are hard coded with the different parameterizations.

The above examples assume a deterministic relationship between a given scenario parameterization and the outcome of the simulation (the same parameterization always leads to the same outcome for a given stack 100). However, this may or may not be the case in practice, and the described techniques can also be applied to numerical test results. For example, when simulation is based on PRISMs, a PRISM might model a distribution over possible perception outputs at each a given time step of the scenario, from which a realistic perception output is sampled probabilistically. This leads to non-deterministic behaviour within the simulator 202, whereby different outcomes may be obtained for the same stack 100 and scenario parameterization because different perception outputs are sampled. Alternatively, or additionally, the simulator 202 may be inherently non-deterministic (e.g. weather or lighting conditions that are randomized/probabilistic to a degree). With non-deterministic simulation, multiple scenario instances could be run for each parameterization. An aggregate pass/fail result could be assigned, e.g. as a count or percentage of pass or failure outcomes.

Whilst the above examples consider AV stack testing, the techniques can be applied to test components of other forms of mobile robot. Other mobile robots are being developed, for example for carrying freight supplies in internal and external industrial zones. Such mobile robots would have no people on board and belong to a class of mobile robot termed UAV (unmanned autonomous vehicle). Autonomous air mobile robots (drones) are also being developed.

A computer system comprises execution hardware which may be configured to execute the method/algorithmic steps disclosed herein and/or to implement a model trained using the present techniques. The term execution hardware encompasses any form/combination of hardware configured to execute the relevant method/algorithmic steps. The execution hardware may take the form of one or more processors, which may be programmable or non-programmable, or a combination of programmable and non-programmable hardware may be used. Examples of suitable programmable processors include general purpose processors based on an instruction set architecture, such as CPUs, GPUs/accelerator processors etc. Such general-purpose processors typically execute computer readable instructions held in memory coupled to the processor and carry out the relevant steps in accordance with those instructions. Other forms of programmable processors include field programmable gate arrays (FPGAs) having a circuit configuration programmable though circuit description code. Examples of non-programmable processors include application specific integrated circuits (ASICs). Code, instructions etc. may be stored as appropriate on transitory or non-transitory media (examples of the latter including solid state, magnetic and optical storage device(s) and the like).

1. A computer-implemented method of evaluating the performance of a trajectory planner in simulation, the method comprising:
running first instances of a scenario in a simulator, the first instances run with a first set of parameterizations of the scenario, the trajectory planner used to control an ego agent responsive in each scenario instance;
evaluating performance of the trajectory planner in each first scenario instance, thereby computing a first set of test results for the first set of parameterizations;
identifying at least one first target parameterization of the first set of parameterizations based on the first set of test results, by comparing a test result computed for the first target parameterization with respective test results computed for a first subset of neighbouring parameterizations of the first set, wherein the first subset of neighbouring parameterizations neighbour the first target parameterization in a parameter space of the scenario; and
based on the first target parameterization, determining a second set of parameterizations of the scenario for running second instances of the scenario for exploring a first subspace of the parameter space in the vicinity of the first target parameterization.

2. The method of claim 1, comprising;
exploring the first subspace of the parameter space by running second instances of the scenario in the simulator with the second set of parameterizations; and
evaluating the performance of the trajectory planner in each second scenario instance, thereby computing a second set of test results for the second scenario instances.

3. The method of claim 2, comprising:
identifying at least one second target parametrization of the second set is identified in the same way, by comparing a test result computed for the second target parameterization with respective test results computed for a second subset of neighbouring parameterizations, wherein the second subset of neighbouring parameterizations neighbour the first target parameterization in a parameter space of the scenario, wherein the second subset of neighbouring parametrizations is a subset of the second set of parameterizations or a subset of the first set of parameterizations and the second set of parameterizations combined; and
based on the second target parameterization, determining a third set of parameterizations of the scenario for running third instances of the scenario for exploring a second subspace of the parameter space in the vicinity of the second target parameterization.

4. The method of claim 2, wherein the second instances are run automatically in response to the identification of the first target parameterisation, or in response to a user input at a user interface.

5. The method of claim 3, wherein the second and third instances are run automatically in response to the identification of the first target parameterisation, or in response to a user input at a user interface, and wherein method continues running instances iteratively until a terminating condition is satisfied.

6. The method of claim 1, wherein the first target parameterization is identified by detecting one or more discrepancies between the test result of the first target parameterization and the respective test results of the first subset of neighbouring parameterizations.

7. The method of claim 6, wherein the first target parameterization is identified by determining that the test result of the first target parameterization differs from each test result of more than a predetermined number of the first subset of neighbouring parameterizations.

8. The method of claim 1, wherein the performance of the trajectory planner is evaluated based on one or more predetermined trajectory evaluation rules.

9. The method of claim 8, wherein the one or more predetermined trajectory evaluation rules pertain to safety, comfort, progress towards a defined goal, or any combination thereof.

10. The method of claim 1, wherein each test result is categorical.

11. The method of claim 10, wherein each test result is computed from a numerical performance score based on at least one threshold.

12. The method of claim 1, wherein the second set of parameterizations is outputted to a user, via a user interface, for manually instigating the second instances of the scenario.

13. The method of claim 1, wherein a test result is computed for each parameterization of the first set of parameterizations from a single first scenario instance or multiple first scenario instances.

14. The method of claim 13, wherein the simulator is non-deterministic, wherein multiple first scenario instances are run for each first parameterization, and wherein the test result for each first parameterization is an aggregate test result for the multiple first scenario instances.

15. The method of claim 1, wherein the second set of parametrizations has a higher density in the first subspace of the parameter space than the first set of parametrizations.

16. The method of claim 15, wherein the first set of parameterizations are uniformly spaced in the parameter space with a first uniform density, and wherein the second set of parameterizations are uniformly spaced with a second uniform density greater than the first uniform density.

17. The method of claim 1, wherein the trajectory planner is tested in combination with a controller, a perception system, and/or a prediction system.

18. The method of claim 1, wherein the trajectory planner is used to control an ego agent responsive to at least one other agent in each scenario instance.

19. A computer system comprising memory and one or more processors configured to:
run first instances of a scenario in a simulator, the first instances run with a first set of parameterizations of the scenario, the trajectory planner used to control an ego agent responsive in each scenario instance;
evaluate a performance of the trajectory planner in each first scenario instance, thereby computing a first set of test results for the first set of parameterizations;
identify at least one first target parameterization of the first set of parameterizations based on the first set of test results, by comparing a test result computed for the first target parameterization with respective test results computed for a first subset of neighbouring parameterizations of the first set, wherein the first subset of neighbouring parameterizations neighbour the first target parameterization in a parameter space of the scenario; and
based on the first target parameterization, determine a second set of parameterizations of the scenario for running second instances of the scenario for exploring a first subspace of the parameter space in the vicinity of the first target parameterization.

20. Non-transitory computer-readable storage media comprising computer program instructions configured, when executed on one or more computer processors, to implement the steps of:
running first instances of a scenario in a simulator, the first instances run with a first set of parameterizations of the scenario, the trajectory planner used to control an ego agent responsive in each scenario instance;
evaluating performance of the trajectory planner in each first scenario instance, thereby computing a first set of test results for the first set of parameterizations;
identifying at least one first target parameterization of the first set of parameterizations based on the first set of test results, by comparing a test result computed for the first target parameterization with respective test results computed for a first subset of neighbouring parameterizations of the first set, wherein the first subset of neighbouring parameterizations neighbour the first target parameterization in a parameter space of the scenario; and
based on the first target parameterization, determining a second set of parameterizations of the scenario for running second instances of the scenario for exploring a first subspace of the parameter space in the vicinity of the first target parameterization.
